(19) United States
(12) Patent Application Publication
(10) Pub. No.: US 2026/0238541 A1
(43) Pub. Date: Aug. 13, 2026

(54) METHOD AND APPARATUS FOR ANALYZING PACKET CAPTURES TO TROUBLESHOOT NETWORK ISSUES

(71) Applicant: Cisco Technology, Inc., San Jose, CA (US)

(72) Inventors: Yathiraj Bhat Udupi, San Jose, CA (US); Abhishek Gupta, Milpitas, CA (US); Waseem A. Siddiqi, Campbell, CA (US); Salil Prabhu, Milpitas, CA (US); Javier I. Contreras Albesa, Cugat del Valles (ES)

(21) Appl. No.: 19/051,373

(22) Filed: Feb. 12, 2025

(51) Int. Cl. H04L 41/0631; H04L 41/16; H04L 43/028

(52) U.S. Cl. CPC H04L 41/0631; H04L 41/16; H04L 43/028

(57) ABSTRACT

In one embodiment, a method includes obtaining packet captures (PCAPs) from a network, and obtaining a first prompt, the first prompt being arranged to identify a first symptom observed in the network. The method also includes obtaining at least one packet signature in response to the first prompt, wherein the at least one packet signature is related to the first symptom, as well as filtering the PCAPs based on the at least one packet signature, wherein filtering the PCAPs includes identifying a set of packet chunks contained in the PCAPs;, and processing the set of packet chunks using at least one LLM, wherein processing the set of packet chunks includes identifying at least one issue, the at least one issue is characterized by the first symptom, and wherein processing the set of packet chunks further includes creating a summary that summarizes the at least one issue.

### TECHNICAL FIELD

The present disclosure relates to networks.

### BACKGROUND

Within networks, issues or problems that have an adverse effect on network performance may arise. The ability to troubleshoot issues arising within a network enables the issues to be addressed. Troubleshooting within a network typically involves capturing packet captures (PCAPs) on substantially all links in the network in order to determine whether there are any drops, misbehaving nodes, and/or protocol-specific issues within the network. Troubleshooting is generally a detailed, time-consuming, manual exercise.

### BRIEF DESCRIPTION OF THE DRAWINGS

The disclosure will be readily understood by the following detailed description in conjunction with the accompanying drawings in which:

FIG. 1 is a process flow diagram which illustrates a method of performing network troubleshooting in accordance with an embodiment.

FIG. 2 is a process flow diagram which illustrates a method of utilizing an analyzer system to perform network troubleshooting in accordance with an embodiment.

FIG. 3 is a diagrammatic representation of an overall framework or system that includes an analyzer system in accordance with an embodiment.

FIG. 4 is a process flow diagram which illustrates a method of creating a retrieval-augmented generation (RAG) vector database in accordance with an embodiment.

FIG. 5 is a diagrammatic representation of an overall framework or system that creates a RAG vector database in accordance with an embodiment.

FIG. 6 is a process flow diagram which illustrates a method of extracting content from a RAG vector database, e.g., step 213 of FIG. 2, in accordance with an embodiment.

FIG. 7 is a process flow diagram which illustrates a method of processing packet captures (PCAPs) and content extracted from a RAG vector database, e.g., step 217 of FIG. 2, in accordance with an embodiment.

FIG. 8 is a process flow diagram which illustrates a method of processing filtered PCAP chunks and relevant chunks of PCAP signatures, e.g., step 717 of FIG. 7, in accordance with an embodiment.

FIG. 9 is a process flow diagram which illustrates a method of utilizing a large language model (LLM) to create an LLM summary, e.g., step 221 of FIG. 2, in accordance with an embodiment.

FIG. 10 is a diagrammatic representation of inputs to and an output from an analyzer system in accordance with an embodiment.

FIG. 11 is a hardware block diagram of a networking/computing device/apparatus/appliance/endpoint that may perform functions associated with any combination of operations in connection with the techniques described with respect to FIGS. 1-10.

### DETAILED DESCRIPTION

### Overview

Techniques are presented herein that enable a user to troubleshoot issues in a network by using large learning models (LLMs) to analyze captured packet captures (PCAPs) and to summarize issues detected in the PCAPs. A database may be created using packet signatures that are labeled to indicate what the packet signatures identify in PCAPs, as for example packet signatures that identify issues. PCAPs obtained from a network may be analyzed using the packet signatures stored in the database, as well as a prompt from a user, to identify issues in the PCAPs obtained from the network. A LLM may process data obtained as a result of the analysis to identify issues in the PCAPs obtained from the network, and provide a summary of the identified issues.

According to one aspect, a method includes obtaining PCAPs, wherein the PCAPs are obtained from a network, and obtaining a first prompt, the first prompt being arranged to identify a first symptom observed in the network. The method also includes obtaining at least one packet signature in response to the first prompt, wherein the at least one packet signature is related to the first symptom, as well as filtering the PCAPs based on the at least one packet signature, wherein filtering the PCAPs includes identifying a set of packet chunks contained in the PCAPs, and processing the set of packet chunks using at least one LLM, wherein processing the set of packet chunks includes identifying at least one issue, the at least one issue is characterized by the first symptom, and wherein processing the set of packet chunks further includes creating a summary that summarizes the at least one issue.

In accordance with another aspect, an apparatus includes one or more network processor units to communicate with devices in a network, and a processor coupled to the one or more network processor units. The processor is configured to perform obtaining PCAPs are from a network, and obtaining a first prompt, the first prompt being arranged to identify a first symptom observed in the network. The processor is also configured to perform obtaining at least one packet signature in response to the first prompt, wherein the at least one packet signature is related to the first symptom, and to perform filtering the PCAPs based on the at least one packet signature, wherein filtering the PCAPs includes identifying a set of packet chunks contained in the PCAPs. The process is still further configured to perform processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

In accordance with yet another aspect, one or more non-transitory computer readable storage media encoded with instructions that, when executed by a processor, cause the processor to perform obtaining PCAPS from a network, obtaining a first prompt arranged to identify a first symptom observed in the network, and obtaining at least one packet signature in response to the first prompt, wherein the at least one packet signature is related to the first symptom. The instructions are further operable to cause the processor to perform filtering the PCAPs based on the at least one packet signature, wherein filtering the PCAPs includes identifying a set of packet chunks contained in the PCAPs, and to perform processing the set of packet chunks using at least one LLM, wherein processing the set of packet chunks includes identifying at least one issue, the at least one issue is characterized by the first symptom, and wherein the instructions are further operable to cause the processor to perform processing the set of packet chunks by creating a summary that summarizes the at least one issue.

### Example Embodiments

As networks operate, issues may arise which have an effect on network performance. The ability to identify the issues, and to address the issues, ensures that network performance may meet expected standards. However, troubleshooting network issues is generally a time-intensive process and, hence, may be both inefficient and expensive Troubleshooting network issues often includes a laborious process of capturing a relatively large amount of packet captures (PCAPs), applying manual filters to the PCAPs, and analyzing the PCAPs in an effort to diagnose issues or problems. For example, a user such as a network administrator may engage in a detailed manual exercise scrolling through packet frames, and using troubleshooting tools to attempt to pinpoint issues in a network during a particular timeframe in order to arrive at a conclusion relating to the issues.

An intelligent packet capture analyzer, or an analyzer system, analyzes captured PCAPs, using a prompt provided by a user, to troubleshoot network issues using at least one large language model (LLM) and a retrieval-augmented generation (RAG) vector database. The prompt may provide a description of symptoms observed by the user in the network. The analyzer system may obtain or extract information from the RAG vector database based on the description provided in the prompt. The obtained or extracted information may be used by the analyzer system to identify packets contained in PCAPs which are consistent with, or essentially match, the information. The identified packets may then be provided to the LLM system such that the LLM system may analyze the identified packets to create a summary related to the analysis. That is, the LLM system may effectively diagnose the network issues.

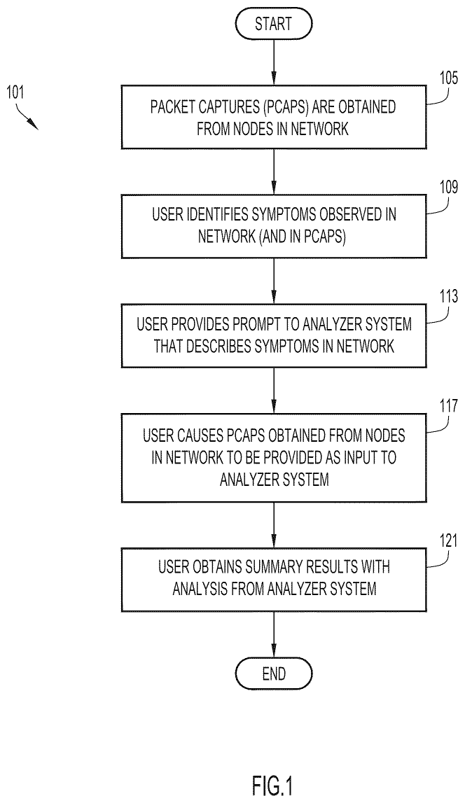

Referring initially to FIG. 1, a method of performing network troubleshooting that utilizes one or more LLMs and a RAG vector database will be described in accordance with an embodiment. A method 101 of performing network troubleshooting begins at a step 105 in which PCAPs are obtained from nodes in a network. That is, data packets that are part of network traffic may be captured or otherwise intercepted as they travel through the network. The PCAPs may be obtained by, or provided to, any suitable system including, but not limited to including, a computing system used by a user that may be part of or otherwise be in communication with the network and/or an intelligent packet analyzer system that may be a part of or otherwise in communication with the network.

In a step 109, a user or a system that is used by the user identifies symptoms, or potential issues, including at least a first symptom observed in the network and, hence, in the PCAPs. For example, a user who is monitoring the network may identify symptoms of an issue or a problem scenario.

After identifying a potential issue in the PCAPs, the user provides a prompt to an analyzer system that describes or identifies the symptoms observed in the network in a step 113. The prompt may be provided by the user to the analyzer system using a computing device that is in communication with the analyzer system. In general, the prompt may include a description of a symptom or an ongoing scenario that is observed in the network with respect to captured PCAPs. The prompt may be provided in any suitable format, as for example a format this is suitable for processing as a part of a semantic search. In one embodiment, the prompt may initially be provided in a natural language format, e.g., a natural language English sentence, but may be translated by the analyzer system into a suitable format such as an encoded vector embedding format that may be used to enable a semantic search in a RAG vector database. In such an embodiment, a language model may enable a prompt to initially be provided in a natural language format and used in a semantic search in a RAG vector database.

Once the prompt is provided to the analyzer system, the user causes PCAPs obtained from nodes in the network to be provided as input to the analyzer system in a step 117. That is, captured PCAPs obtained from nodes which are exhibiting a symptom are provided to the analyzer system.

In a step 121, after the analyzer system processes the PCAPs and the prompt, the user obtains summary results from the analyzer system. The summary results may generally include a summary, as for example a summary generated by an LLM, of the analysis performed on the PCAPs and the prompt. The summary results may provide insight into one or more reasons why the symptom was observed, and may identify the problem or issue scenario that cause the symptom. Upon the user obtaining the summary results, the method of performing network troubleshooting is completed.

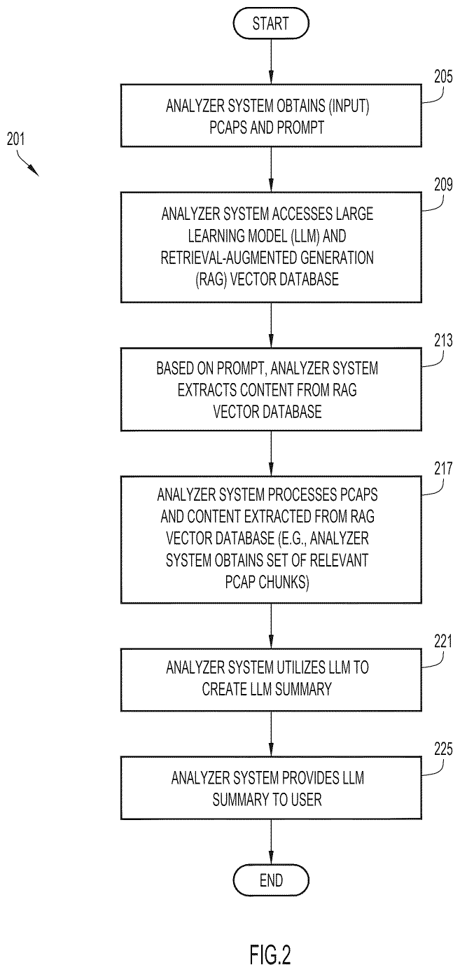

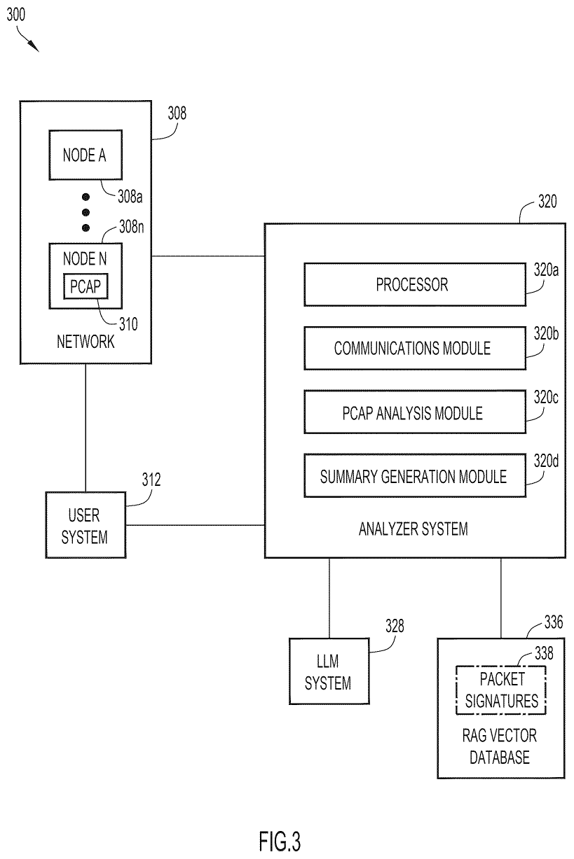

Using a user prompt and a set of PCAPs, an analyzer system may perform network troubleshooting. With reference to FIG. 2, a method of utilizing an analyzer system to perform network troubleshooting will be described in accordance with an embodiment. A method 201 of utilizing an analyzer system begins at a step 205 in which the analyzer system obtains PCAPs and a prompt, e.g., a prompt from a user, as input. The PCAPs and prompt may be obtained through a network, as will be discussed below with reference to FIG. 3.

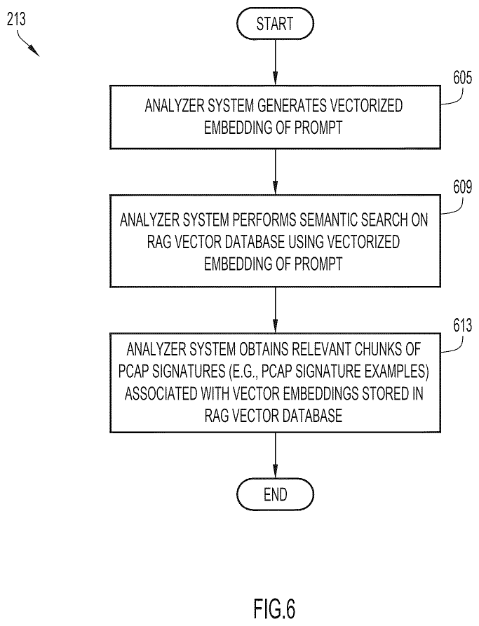

Once the analyzer system obtains PCAPs and a prompt, the analyzer system accesses at least one LLM and at least one RAG vector database in a step 209. Upon accessing the LLM and the RAG vector database, the analyzer system extracts content from the RAG vector database in a step 213. The content extracted from the RAG vector database is identified based at least in part upon the prompt. One method of extracting content from a RAG vector database will be described in more detail below with respect to FIG. 6.

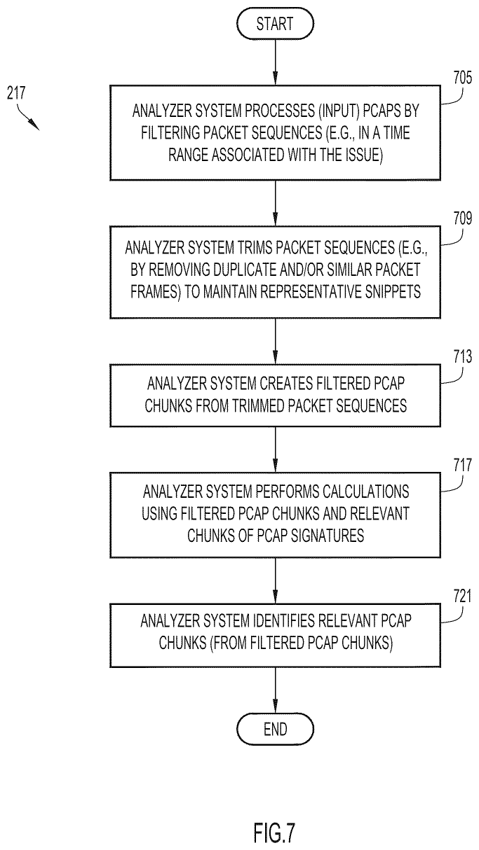

In a step 217, the analyzer system processes the PCAPs and the content extracted from the RAG vector database. For example, the PCAPs and the content may be processed to obtain or to otherwise identify a set of relevant PCAP chunks in the PCAPs which indicate a particular issue or problem. One method of processing PCAPs and content extracted from the RAG vector database will be discussed below with reference to FIG. 7.

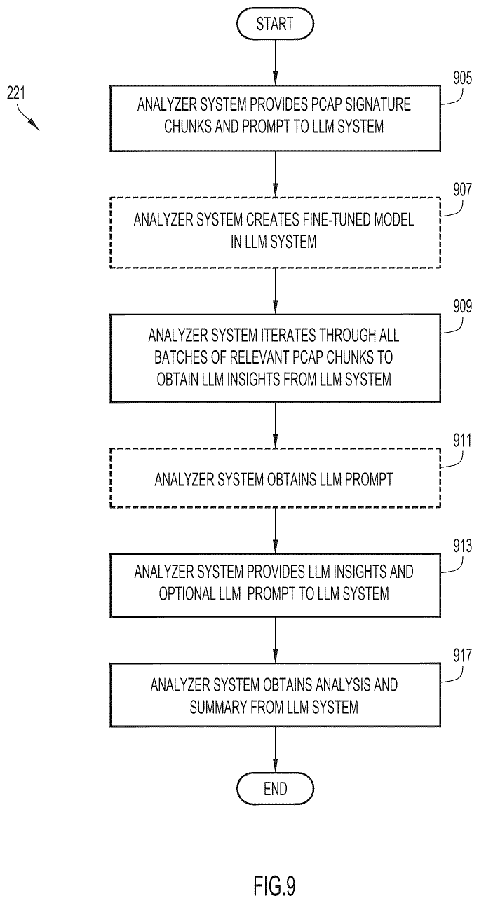

After the PCAPs and the content extracted from the RAG vector database are processed, the process flow moves to a step 221 in which the analyzer system utilizes the LLM to create an LLM summary. The LLM summary may generally summarize the results of processing the PCAPs and the content extracted from the RAG vector database, as will be described with reference to FIG. 9. The LLM summary, once created, is provided to a user, as for example to a computer system that the user may access, in a step 225, and the method of utilizing an analyzer system is completed.

In general, an analyzer system is part of an overall framework or system that monitors a network and may perform troubleshooting with respect to the network. FIG. 3 is a diagrammatic representation of an overall framework or system that includes an analyzer system in accordance with an embodiment. An overall framework 300 includes a network 308, a user system 312, an analyzer system 320, at least one LLM system 328, and at least one RAG vector database 336. Network 308 includes a plurality of nodes 308a-n that communicate with each other on wireless and/or wired communication links. Packets may generally be exchanged between various nodes 308a-n within network 308. While node 308a and node 308n are shown, it should be appreciated that the number of nodes 308a-n may vary widely. In one embodiment, node 308n includes a PCAP capture module 310 that is arranged to capture PCAPs within network 308.

Network 308 is also in communication with user system 312 and analyzer system 320. User system 312, which may includes a computing system or other device that enables a user to effectively monitor network 308 and provide information, e.g., prompts, to analyzer system 320. PCAPs captured by PCAP capture module 310 may be provided by network 308 as input to analyzer system 320.

Analyzer system 320 includes hardware and/or software code devices configured to cooperate with LLM system 328 and RAG vector database 336 to process PCAPs obtained from network 308 and a prompt obtained from user system 312. Processing PCAPs and a prompt enables analyzer system 320 to generate a summary report that provides information relating to issues or problems that are identified in PCAPs using the prompt. The summary report generated by analyzer system 320 may then be provided to user system 312 such that a user may review the summary report and act with respect to network 308, if appropriate.

Analyzer system 320 includes a processor 320a, a communications module 320b, a PCAP analysis module 320c, and a summary generation module 320d. Processor 320a includes one or more microprocessors, or processing units, configured to execute logic and/or program code devices included in communications module 320b, PCAP analysis module 320c, and/or summary generation module 320d. Communications module 320b may include one or more communications ports, and is configured to enable analyzer system 320 to communicate with network 308, user system 312, LLM system 328, and RAG vector database 336. Communications module 320b may be arranged to communicate wirelessly and/or on a wired connection. PCAP analysis module 320c may be configured to obtain captured PCAPs, and to process the PCAPs to identify one or more issues or problems exhibited by the PCAPs. PCAP analysis module 320c may obtain information from LLM system 328 and RAG vector database 336, and may utilize the obtained information to identify the issues or problems characterized in the PCAPs. Summary generation module 320d cooperates with LLM system 328 to create a summary of the issues or problems characterized in the PCAPs,

LLM system 328 includes one or more LLMs. As will be appreciated by those skilled in the art, an LLM is an artificial intelligence or machine learning model that applies neural network methods with parameters to understand language or text. An LLM generally has natural language understanding and natural language processing abilities. In one embodiment, analyzer system 320 may provide information to LLM system 328, and LLM system 328 may process the information to provide output, as for example a summary of issues detected in the PCAPs, to analyzer system 320.

RAG vector database 336 is arranged to, upon a request or a query from analyzer system 320, return or otherwise provide information in response to the request. Data is stored in RAG vector database 336 as vectors, which may generally be created from data, e.g., data relating to packets having packet signatures 338, using embedding models. That is, RAG vector database 336 may effectively be a repository of vectors created using embedding models, with the vectors having packet signatures 338.

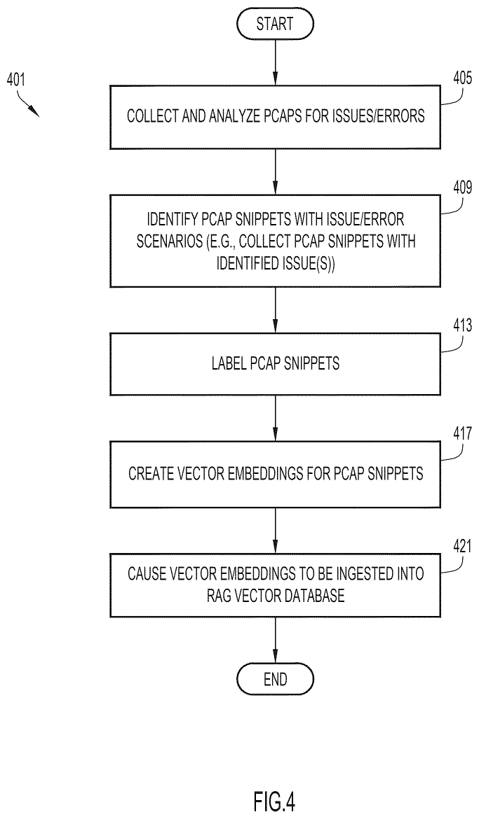

FIG. 4 is a process flow diagram which illustrates a method of creating a RAG vector database such as RAG vector database 336 in accordance with an embodiment. A method 401 of creating or populating a RAG vector database 336 begins at a step 405 in which PCAPs are obtained and analyzed for issues and/or errors. The PCAPs, which may be snippets of PCAPs considered to be relevant for the particular RAG vector database being created, may be analyzed by a system and/or a human.

In a step 409, PCAP snippets which contain issue and/or error scenarios are identified. That is, PCAP snippets include identified issues are collected. A PCAP snippet may generally include a text summary which identifies the contents of the PCAP snippet. Such a text summary may include, but is not limited to including, a source, a destination, a protocol, a byte count, and/or an error. In one embodiment, the PCAP snippets which contain issues may be PCAP snippets which correspond to scenarios which are relatively common, as for example problem scenarios that have been observed in networks and scenarios for which customer escalations are relatively prevalent.

The PCAP snippets are labelled in a step 413, after issue and/or error scenarios are identified in the PCP snippets. For example, a PCAP snippet with a signature that identifies an extensible authentication protocol (EAP) failure that results in the deauthentication of a client may be labelled as “EAP failure resulting in client deauthentication while client is trying to authenticate to an access point in a wireless network.”

Once the PCAP snippets are labelled, vector embeddings are created for the PCAP snippets in a step 417. Vector embeddings may be generated using an embeddings model, e.g., a fine-tuned embeddings model. PCAP snippets may be provided to the embedding model, along with explanations, to enable vector embeddings to be created. The explanations may include, but are not limited to including, explanations of when and where the PCAP snippets were captured. It should be appreciated that creating vector embeddings may generally involve translating text, given a context of the text, to a vector for using an embeddings model. Each word in a text sentence may be translated to a number in a vector representation based on mapping provided by a model.

After the vector embeddings are created, the vector embeddings are ingested into the RAG vector database in a step 421. The method of creating or populating a RAG vector database is completed upon ingesting the vector embeddings into the RAG vector database.

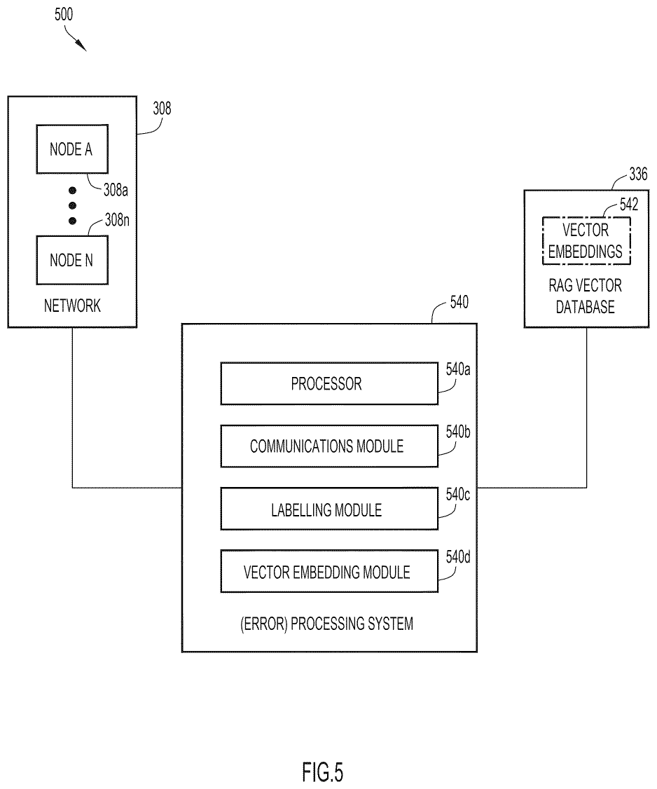

Referring next to FIG. 5, an overall training framework or system that enables a RAG vector database, as for example RAG vector database 336 of FIG. 3, to be created or otherwise populated will be described in accordance with an embodiment. An overall training framework or system 500 that supports the creation of a RAG vector database 336 includes network 308 and a processing system 540, e.g., an error processing system. Processing system 540 is arranged to communicate with network 308, as for example with nodes 308a-n in network 308, and with RAG vector database 336.

Processing system 540 may obtain PCAPs from network 308, and process the obtained PCAPs to create vector embeddings 542 which may be ingested into RAG vector database 336. Processing system 540 includes a processor 540a, a communications module 540b, a labelling module 540c, and a vector embedding module 540d. Processor 540a includes one or more microprocessors or processing units configured to execute logic or program code devices included in communications module 540b, labelling module 540c, and vector embedding module 540d. Communications module 540b may include one or more input/output interfaces, as for example ports, which enable processing system 540 to communicate on wired links to or wirelessly with network 308 and RAG vector database 336. Labelling module 540c is configured to enable labels to be added to PCAP snippets. The labels may be generated by labelling module 540c. In one embodiment, labelling module 540c obtains labels from a user, and applies the labels to PCAP snippets. Vector embedding module 540d creates vector embeddings 542 based on labeled PCAP snippets.

Vector embeddings 542 may be extracted, or otherwise obtained from, RAG vector database 336 during a network troubleshooting process, as discussed above with respect to FIG. 1. With reference to FIG. 6, a method of extracting content from a RAG vector database, e.g., step 213 of FIG. 2, will be described in accordance with an embodiment. Method or step 213 of extracting content from a RAG vector database begins at a step 605 in which an analyzer system, as for example analyzer system 320 of FIG. 3, generates a vectorized embedding of a prompt provided by a user. As mentioned above, the prompt may include information relating to a particular problem scenario or a symptom that is exhibited by a network. For example, if a network appears to have authentication issues, the prompt may state “a wireless client is experiencing authentication issues, please help analyze the provided PCAPs,” and a vectorized embedding of the prompt may be created.

In a step 609, the analyzer system performs a semantic search on a RAG vector database using the vectorized embedding of the prompt. The semantic search involves searching through labelled PCAP signatures in the RAG vector database based on the vectorized embedding of the prompt.

Once the semantic search is performed, the analyzer system obtains relevant chunks of PCAP signatures associated with vector embeddings stored in the RAG vector database in a step 613. By way of example, the relevant chunks may be the chunks with labelled PCAP signatures which most closely match the description provided in the prompt. The identification of relevant chunks may vary widely. That is, the number of chunks identified as relevant, as well as the factors used to determine relevancy, may vary. For instance, the top “k” substantially matching chunks of PCAP signature examples, or labelled PCAP signatures, in the RAG vector database may be identified, where “k” may be a number or a percentage determined by a network administrator. After the relevant chunks of PCAP signatures are identified, the method of extracting content from a RAG vector database is completed.

The relevant chunks of PCAP signatures are used to facilitate identifying issues in the captured PCAPs that are analyzed by the analyzer system. FIG. 7 is a process flow diagram which illustrates a method of processing PCAPs and content extracted from a RAG vector database, e.g., step 217 of FIG. 2, in accordance with an embodiment. Method or step 217 or processing PCAPs and content extracted from a RAG vector database begins at a step 705 in which the analyzer system processes PCAPs, e.g., PCAPs or PCAP files obtained by the analyzer system as input, by filtering packet sequences included in the PCAPs. Filtering PCAPs may generally include reducing the number of PCAPs to be compared to the content such as relevant chunks of PCAP signatures extracted from a RAG vector database. Thus, processing entire PCAP files may be substantially avoided. By way of example, packet sequences included in the PCAPs may be filtered based upon the time range, using time stamps, during which the issue or symptoms were observed.

In a step 709, the analyzer system trims the packet sequences to maintain representative snippets. Trimming the packet sequences may include, but is not limited to including, removing duplicate and/or similar packet frames from the packet sequences. By way of example, packet frames with matching source, destination, and protocols may be trimmed such that substantially only representative packet frames, or snippets, are maintained.

Once the packet sequences are trimmed, the analyzer system creates filtered PCAP chunks in a step 713 from the trimmed packet sequences. It should be appreciated that the size of snippets, or PCAP snippets, may vary. Snippets may effectively be broken down into substantially fixed size chunks based on packet frame counts.

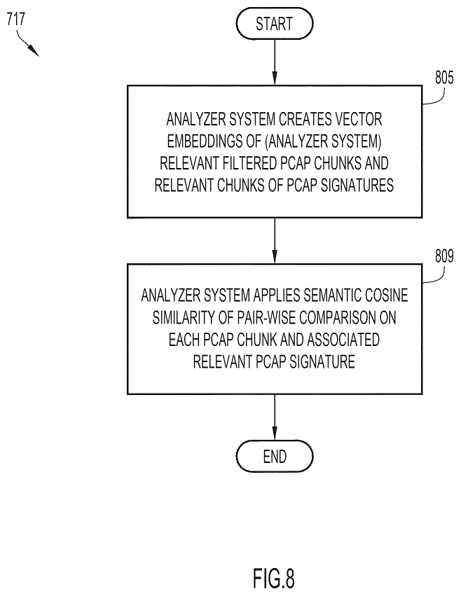

After the filtered PCAP chunks are created or otherwise collected, the analyzer system performs calculations or, more generally, processes, the filtered PCAP chunks and the relevant chunks of the PCAP signatures obtained from the RAG vector database in a step 717. One method of performing calculations on the filtered PCAP chunks and the relevant chunks of the PCAP signatures will be discussed below with reference to FIG. 8.

The analyzer system identifies relevant PCAP chunks, from the filtered PCAP chunks, in a step 721. In one embodiment, the performance of the semantic cosine similarity of pair-wise calculation performed in step 717 enables a subset of the filtered PCAP chunks to essentially be identified as the most relevant filtered PCAP chunks to further analyze. The subset of the filtered PCAP chunks that is selected may be selected based on any suitable criterion. By way of example, the subset of the filtered PCAP chunks may be the filtered PCAP chunks which meet or exceed a predetermined threshold. The threshold may be, but is not limited to being, a similarity measure which substantially characterizes how similar a filtered PCAP chunk is to content extracted from the RAG vector database. The threshold may be substantially customizable, as for example customizable to a value between approximately zero and approximately one. A customizable threshold may initially be set to approximately 0.5, and may be adjusted to provide more constraints and/or lower to provide fewer constraints, e.g., more constraints may involve a threshold closer to approximately one and fewer constraints may involve a threshold closer to approximately zero. Once the relevant filtered PCAP chunks are identified, the method of processing PCAPs and content extracted from a RAG vector database is completed.

FIG. 8 is a process flow diagram which illustrates a method of processing filtered PCAP chunks, or relevant filtered PCAP chunks, and relevant chunks of PCAP signatures obtained from a RAG vector database, e.g., step 717 of FIG. 7, in accordance with an embodiment. Method or step 717 of processing relevant filtered PCAP chunks and relevant chunks of PCAP signatures obtained from a RAG vector database begins at a step 805 in which the analyzer system creates vector embeddings of relevant filtered PCAP chunks and relevant chunks of PCAP signatures.

Once the vector embeddings are created, the analyzer system applies semantic similarity calculations on the vector embeddings of the filtered PCAP chunks and the relevant chunks of PCAP signatures obtained from the RAG vector database in a step 809. In one embodiment, a semantic cosine similarity of pair-wise calculation or comparison may be applied on each PCAP chunk and associated relevant PCAP signature. After the semantic cosine similarity of pair-wise comparison is applied or implemented, the method of processing relevant filtered PCAP chunks and relevant chunks of PCAP signatures obtained from a RAG vector database is completed.

FIG. 9 is a process flow diagram which illustrates a method of utilizing a large language model (LLM) to create an LLM summary, e.g., step 221 of FIG. 2, in accordance with an embodiment. Method or step 221 of creating an LLM summary begins at a step 905 in which the analyzer system provides relevant filtered PCAP chunks and a prompt to the LLM system. The relevant filtered PCAP chunks may be provided in batches. The prompt may be a user prompt, and may be arranged to indicate the issue to be identified in the relevant filtered PCAP chunks and summarized.

From step 905, process flow proceeds to an optional step 907 in which the analyzer system creates a fine-tuned model in the LLM system. Creating a fine-tuned model may include using packet samples with corresponding explanations to improve the effectiveness of vector embeddings. It should be appreciated that creating a fine-tuned model by updating a model such as a base or standard LLM model may include utilizing training datasets relevant to a specific domain, e.g., using PCAP packet samples with corresponding explanations and summaries, to refine the model.

In a step 909, the analyzer system iterates through substantially all batches of relevant filtered PCAP chunks to obtain LLM insights, or interim LLM insights, from the LLM system. The analyzer system may provide the batches of relevant filtered PCAP chunks to the LLM system, and the LLM system may effectively create a response, e.g., an interim LLM response, for each batch of relevant filtered PCAP chunks.

In an optional step 911, the analyzer system obtains an LLM prompt, or a prompt from a user that may provide additional information to the LLM system. For example, the LLM prompt may be arranged to instruct the LLM system how to substantially summarize the interim LLM insights or responses, and may request an explanation of any analysis to be performed as well as a conclusion formulated from the analysis.

Once the analyzer system obtains interim LLM insights and optionally obtains an LLM prompt, the analyzer system provides the interim LLM insights and the optional LLM prompt to the LLM system in a step 913. The optional LLM prompt and the interim LLM insights may be provided to the LLM system such that the LLM system may analyze the interim LLM insights to generate a summary of the interim LLM insights. In one embodiment, when the optional LLM prompt is provided, the LLM system may provide analysis or otherwise tailor a summary report based on information provided in the optional LLM prompt.

After interim LLM insights and, optionally, an LLM prompt are provided to the LLM system, the analyzer system obtains an analysis and a summary from the LLM system in a step 917. The analysis and the summary generally provides information as to issues or problems identified in the relevant filtered PCAP chunks, e.g., the analysis and the summary may diagnose issues or problems indicated in the PCAPs obtained from a network. The information provided in the analysis and the summary may provide an explanation of the issues or problems, as well as an explanation of the analysis. The method of creating an LLM summary is completed upon the analyzer system obtaining an analysis and a summary from an LLM system.

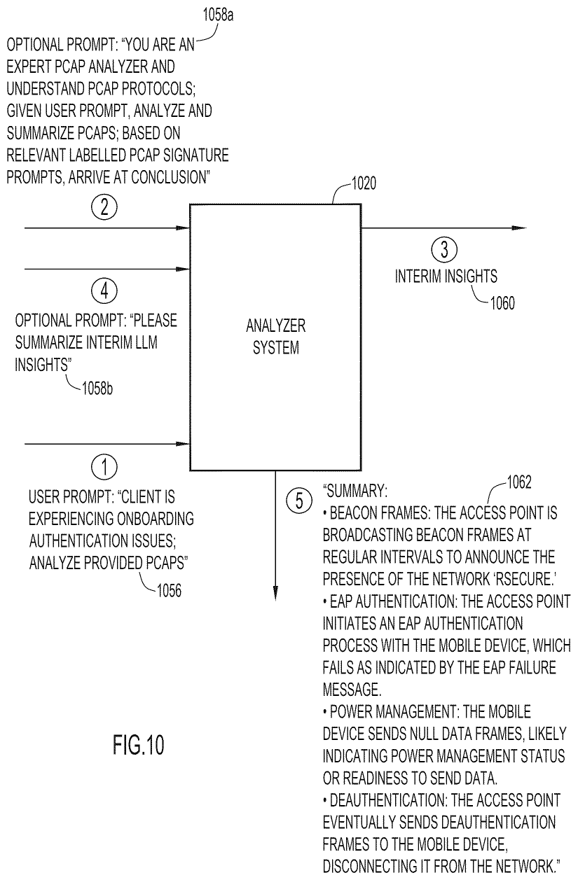

Typically, as previously mentioned, a user system such as user system 312 of FIG. 3 may communicate with or interact with an analyzer system such as analyzer system 320 of FIG. 3 to troubleshoot issues in a network such as network 308 of FIG. 3. An analyzer system may generally obtains an input from a user system and from a network, and may provide output to the user system in response to the input. FIG. 10 is a diagrammatic representation of inputs to and an output from an analyzer system in accordance with an embodiment. An analyzer system 1020, or an intelligent packet capture analyzer, may be arranged to obtain information from, and provide information to, various sources including, but not limited to including, user systems (not shown) and network nodes (not shown). It should be appreciated that a user prompt 1056, an optional prompt 1058a, and optional prompt 1058b, and a summary 1062 are examples of suitable prompts. In other words, user prompt 1056, optional prompt 1058a, optional prompt 1058b, and summary 1062 are not limited to the examples as shown.

At a time T1, an analyzer system 1020 may obtain user prompt 1056 at approximately the same time that analyzer system 1020 may obtain PCAPs for analysis. As shown, user prompt 1056 may describe a symptom observed in a network, e.g., “client is experiencing onboarding authentication issues; analyze provided PCAPs.”

At a time T2, optional prompt 1058a may be provided by a user. Optional prompt 1058a may be used to provide information which may be used to enable analyzer system 1020 to refine a query to an LLM system (not shown). For example, optional prompt 1058a may indicate that insights are to be provided from the point-of-view of “you are an expert PCAP analyzer and understand PCAP protocols; given user prompt, analyze and summarize PCAPs; based on relevant labelled PCAP signature prompts, arrive at conclusion.”

In response to user prompt 1056 and optional prompt 1058a, analyzer system 1020 may, in cooperation with an LLM system (not shown), obtain one or more interim insights 1060 and provide one or more interim insights 1060 as output at a time T3, as for example to a user system (not shown).

At a time T4, optional prompt 1058b may be provided to analyzer system 1020 to provide additional information which may be used to generate summary 1062. As shown, optional prompt 1058b may provide general instructions to “please summarize interim LLM insights,” although it should be appreciated that optional prompt 1058b may provide instructions which provide more detail. For example, optional prompt 1058b may request a specific type of summary, or a particular point-of-view that is to be assumed when generating summary 1062.

At a time T5, summary 1062 is provided, e.g., provided to a user system (not shown). Summary 1062 may summarize the results of an analysis of PCAPs based at least on user prompt 1056. Summary 1062 indicates one or more issues, errors, and/or problems associated with interim insights 1060 and, hence, captured PCPs. In the embodiment as shown, summary 1062 identifies issues, errors, and/or problems associated with beacon frames, EAP authentication, power management, and deauthentication.

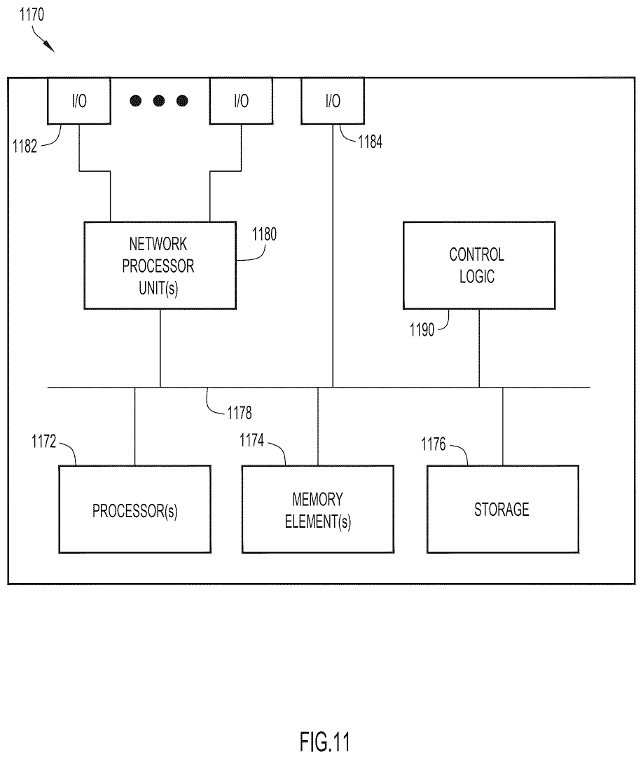

FIG. 11 is a hardware block diagram of a networking/computing device/apparatus/appliance/endpoint that may perform functions associated with any combination of operations in connection with the techniques described with respect to FIGS. 1-10. It should be appreciated that FIG. 11 provides only an illustration of one example embodiment and does not imply any limitations with regard to the environments in which different example embodiments may be implemented. Many modifications to the depicted environment may be made.

In at least one embodiment, the computing device 1170 may be any apparatus that may include one or more processor(s) 1172, one or more memory element(s) 1174, storage 1176, a bus 1178, one or more network processor unit(s) 1180 interconnected with one or more network input/output (I/O) interface(s) 1182, one or more I/O interface(s) 1184, and control logic 1190. In various embodiments, instructions associated with logic for computing device 1170 may overlap in any manner and are not limited to the specific allocation of instructions and/or operations described herein.

In at least one embodiment, processor(s) 1172 is/are at least one hardware processor configured to execute various tasks, operations and/or functions for device 1170 as described herein according to software and/or instructions configured for device 1170. Processor(s) 1172 (e.g., a hardware processor) may execute any type of instructions associated with data to achieve the operations detailed herein. In one example, processor(s) 1172 may transform an element or an article (e.g., data, information) from one state or thing to another state or thing. Any of potential processing elements, microprocessors, digital signal processor, baseband signal processor, modem, PHY, controllers, systems, managers, logic, and/or machines described herein may be construed as being encompassed within the broad term ‘processor’.

In at least one embodiment, one or more memory element(s) 1174 and/or storage 1176 is/are configured to store data, information, software, and/or instructions associated with device 1170, and/or logic configured for memory element(s) 1174 and/or storage 1176. For example, any logic described herein (e.g., control logic 1190) may, in various embodiments, be stored for device 1170 using any combination of memory element(s) 1174 and/or storage 1176. Note that in some embodiments, storage 1176 may be consolidated with one or more memory elements 1174 (or vice versa), or may overlap/exist in any other suitable manner. In one or more example embodiments, process data is also stored in the one or more memory elements 1174 for later evaluation and/or process optimization.

In at least one embodiment, bus 1178 may be configured as an interface that enables one or more elements of device 1170 to communicate in order to exchange information and/or data. Bus 1178 may be implemented with any architecture designed for passing control, data and/or information between processors, memory elements/storage, peripheral devices, and/or any other hardware and/or software components that may be configured for device 1170. In at least one embodiment, bus 1178 may be implemented as a fast kernel-hosted interconnect, potentially using shared memory between processes (e.g., logic), which may enable efficient communication paths between the processes.

In various embodiments, network processor unit(s) 1180 may enable communication between computing device 1170 and other systems, entities, etc., via network I/O interface(s) 1182 (wired and/or wireless) to facilitate operations discussed for various embodiments described herein. In various embodiments, network processor unit(s) 1180 may be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1170 and other systems, entities, etc. to facilitate operations for various embodiments described herein. In various embodiments, network I/O interface(s) 1182 may be configured as one or more Ethernet port(s), Fibre Channel ports, any other I/O port(s), and/or antenna(s)/antenna array(s) now known or hereafter developed. Thus, the network processor unit(s) 1180 and/or network I/O interface(s) 1182 may include suitable interfaces for receiving, transmitting, and/or otherwise communicating data and/or information in a network environment.

I/O interface(s) 1184 allow for input and output of data and/or information with other entities that may be connected to device 1170. For example, I/O interface(s) 1184 may provide a connection to external devices such as a keyboard, keypad, a touch screen, and/or any other suitable input device now known or hereafter developed. In some instances, external devices may also include portable computer readable (non-transitory) storage media such as database systems, thumb drives, portable optical or magnetic disks, and memory cards.

In various embodiments, control logic 1190 may include instructions that, when executed, cause processor(s) 1172 to perform operations, which may include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1190) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the even the device 1170 is an endpoint (such as telephone, mobile phone, desk phone, conference endpoint, etc.), then the device 1170 may further include a sound processor, a speaker that plays out audio and a microphone that detects audio. The sound processor may be a sound accelerator card or other similar audio processor that may be based on one or more ASICs and associated digital-to-analog and analog-to-digital circuitry to convert signals between the analog domain and digital domain. In some forms, the sound processor may include one or more digital signal processors (DSPs) and be configured to perform some or all of the operations of the techniques presented herein. The device 1170 may further include a video camera and a video processor.

Although only a few embodiments have been described in this disclosure, it should be understood that the disclosure may be embodied in many other specific forms without departing from the spirit or the scope of the present disclosure. By way of example, while a network troubleshooting framework has been described as including a network, a user system, an analyzer system, one or more LLM systems, and one or more RAG vector databases, a network troubleshooting framework is not limited to the framework described above with respect to FIG. 3. In one embodiment, a user system, an analyzer system, one or more LLM systems and one or more RAG vector databases may effectively be included in a network within which PCAPs are captured.

The steps included in the methods described above may vary without departing from the spirit or the scope of the disclosure. In general, the steps associated with the methods described above are not limited to being performed in the order indicated.

In some aspects, the techniques described herein relate to a method including: obtaining packet captures (PCAPs), wherein the PCAPs are obtained from a network; obtaining a first prompt, the first prompt being arranged to identify a first symptom observed in the network; obtaining at least one packet signature in response to the first prompt, wherein the at least one packet signature is related to the first symptom; filtering the PCAPs based on the at least one packet signature, wherein filtering the PCAPs includes identifying a set of packet chunks contained in the PCAPs; and processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

In some aspects, the techniques described herein relate to a method wherein obtaining the at least one packet signature in response to the first prompt includes obtaining the at least one packet signature from a retrieval-augmented generation (RAG) vector database.

In some aspects, the techniques described herein relate to a method wherein the at least one packet signature is included in at least one vector embedding, and wherein obtaining the at least one packet signature from the RAG vector database includes extracting at least on chunk of the packet signature from the at least one vector embedding.

In some aspects, the techniques described herein relate to a method wherein the first symptom is observed in the network in a time range, and wherein identifying the set of packet chunks contained in the PCAPs includes filtering packet sequences included in the PCAPs based on the time range and trimming the packet sequences by removing duplicate packet frames included in the packet sequences.

In some aspects, the techniques described herein relate to a method wherein filtering the PCAPs based on the at least one packet signature includes creating at least a first vector embedding of the PCAPs, obtaining at least a second vector embedding that includes that at least one packet signature, and performing a semantic similarity calculation on the at least first vector embedding and the at least second vector embedding.

In some aspects, the techniques described herein relate to a method wherein performing the semantic similarity calculation includes identifying at least a first packet chunk that meets a threshold, the threshold being associated with the at least one packet signature, and wherein the first packet chunk is included in the set of packet chunks.

In some aspects, the techniques described herein relate to a method wherein processing the set of packet chunks using the at least one LLM includes providing a plurality of interim insights, the method further including: obtaining a second prompt, wherein creating the summary that summarizes the at least one issue includes processing the plurality of interim insights based on the second prompt.

In some aspects, the techniques described herein relate to an apparatus including: one or more network processor units to communicate with devices in a network; and a processor coupled to the one or more network processor units and configured to perform: obtaining packet captures (PCAPs), wherein the PCAPs are obtained from a network; obtaining a first prompt, the first prompt being arranged to identify a first symptom observed in the network; obtaining at least one packet signature in response to the first prompt, wherein the at least one packet signature is related to the first symptom; filtering the PCAPs based on the at least one packet signature, wherein filtering the PCAPs includes identifying a set of packet chunks contained in the PCAPs; and processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

In some aspects, the techniques described herein relate to an apparatus wherein obtaining the at least one packet signature in response to the first prompt includes obtaining the at least one packet signature from a retrieval-augmented generation (RAG) vector database.

In some aspects, the techniques described herein relate to an apparatus wherein the at least one packet signature is included in at least one vector embedding, and wherein obtaining the at least one packet signature from the RAG vector database includes extracting at least on chunk of the packet signature from the at least one vector embedding.

In some aspects, the techniques described herein relate to an apparatus wherein the first symptom is observed in the network in a time range, and wherein identifying the set of packet chunks contained in the PCAPs includes filtering packet sequences included in the PCAPs based on the time range and trimming the packet sequences by removing duplicate packet frames included in the packet sequences.

In some aspects, the techniques described herein relate to an apparatus wherein filtering the PCAPs based on the at least one packet signature includes creating at least a first vector embedding of the PCAPs, obtaining at least a second vector embedding that includes that at least one packet signature, and performing a semantic similarity calculation on the at least first vector embedding and the at least second vector embedding.

In some aspects, the techniques described herein relate to an apparatus wherein performing the semantic similarity calculation includes identifying at least a first packet chunk that meets a threshold, the threshold being associated with the at least one packet signature, and wherein the first packet chunk is included in the set of packet chunks.

In some aspects, the techniques described herein relate to one or more non-transitory computer readable storage media encoded with instructions that, when executed by a processor, cause the processor to perform: obtaining packet captures (PCAPs), wherein the PCAPs are obtained from a network; obtaining a first prompt, the first prompt being arranged to identify a first symptom observed in the network; obtaining at least one packet signature in response to the first prompt, wherein the at least one packet signature is related to the first symptom; filtering the PCAPs based on the at least one packet signature, wherein filtering the PCAPs includes identifying a set of packet chunks contained in the PCAPs; and processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

In some aspects, the techniques described herein relate to one or more non-transitory computer readable storage media wherein the instructions that cause the processor to perform obtaining the at least one packet signature in response to the first prompt include instructions that cause the process to perform obtaining the at least one packet signature from a retrieval-augmented generation (RAG) vector database.

In some aspects, the techniques described herein relate to one or more non-transitory computer readable storage media wherein the at least one packet signature is included in at least one vector embedding, and wherein the instructions that cause the processor to perform obtaining the at least one packet signature from the RAG vector database include instructions that cause the processor to perform extracting at least on chunk of the packet signature from the at least one vector embedding.

In some aspects, the techniques described herein relate to one or more non-transitory computer readable storage media wherein the first symptom is observed in the network in a time range, and wherein the instructions that cause the processor to perform identifying the set of packet chunks contained in the PCAPs include instructions that cause the processor to perform filtering packet sequences included in the PCAPs based on the time range and trimming the packet sequences by removing duplicate packet frames included in the packet sequences.

In some aspects, the techniques described herein relate to one or more non-transitory computer readable storage media wherein the instructions that cause the processor to perform filtering the PCAPs based on the at least one packet signature include instructions that cause the processor to perform creating at least a first vector embedding of the PCAPs, instructions that cause the processor to perform obtaining at least a second vector embedding that includes that at least one packet signature, and instructions that cause the processor to perform performing a semantic similarity calculation on the at least first vector embedding and the at least second vector embedding.

In some aspects, the techniques described herein relate to one or more non-transitory computer readable storage media wherein the instructions that cause the processor to perform performing the semantic similarity calculation include instructions that cause the processor to perform identifying at least a first packet chunk that meets a threshold, the threshold being associated with the at least one packet signature, and wherein the first packet chunk is included in the set of packet chunks.

In some aspects, the techniques described herein relate to one or more non-transitory computer readable storage media wherein the instructions that cause the processor to perform processing the set of packet chunks using the at least one LLM include instructions that cause the processor to perform providing a plurality of interim insights, the one or more non-transitory computer readable storage media further including: instructions that cause the processor to perform obtaining a second prompt, wherein creating the summary that summarizes the at least one issue includes processing the plurality of interim insights based on the second prompt.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which may be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1176 and/or memory elements(s) 1174 may store data, software, code, instructions (e.g., processor instructions), logic, parameters, combinations thereof, and/or the like used for operations described herein. This includes the storage 1176 and/or memory elements(s) 1174 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value.

Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining packet captures (PCAPs), wherein the PCAPs are obtained from a network;
obtaining a first prompt, the first prompt being arranged to identify a first symptom observed in the network;
obtaining at least one packet signature in response to the first prompt, wherein the at least one packet signature is related to the first symptom;
filtering the PCAPs based on the at least one packet signature, wherein filtering the PCAPs includes identifying a set of packet chunks contained in the PCAPs; and
processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

2. The method of claim 1 wherein obtaining the at least one packet signature in response to the first prompt includes obtaining the at least one packet signature from a retrieval-augmented generation (RAG) vector database.

3. The method of claim 2 wherein the at least one packet signature is included in at least one vector embedding, and wherein obtaining the at least one packet signature from the RAG vector database includes extracting at least on chunk of the packet signature from the at least one vector embedding.

4. The method of claim 1 wherein the first symptom is observed in the network in a time range, and wherein identifying the set of packet chunks contained in the PCAPs includes filtering packet sequences included in the PCAPs based on the time range and trimming the packet sequences by removing duplicate packet frames included in the packet sequences.

5. The method of claim 1 wherein filtering the PCAPs based on the at least one packet signature includes creating at least a first vector embedding of the PCAPs, obtaining at least a second vector embedding that includes that at least one packet signature, and performing a semantic similarity calculation on the at least first vector embedding and the at least second vector embedding.

6. The method of claim 5 wherein performing the semantic similarity calculation includes identifying at least a first packet chunk that meets a threshold, the threshold being associated with the at least one packet signature, and wherein the first packet chunk is included in the set of packet chunks.

7. The method of claim 1 wherein processing the set of packet chunks using the at least one LLM includes providing a plurality of interim insights, the method further including:
obtaining a second prompt, wherein creating the summary that summarizes the at least one issue includes processing the plurality of interim insights based on the second prompt.

8. An apparatus comprising:
one or more network processor units to communicate with devices in a network; and
a processor coupled to the one or more network processor units and configured to perform:
obtaining packet captures (PCAPs), wherein the PCAPs are obtained from a network;
obtaining a first prompt, the first prompt being arranged to identify a first symptom observed in the network;
obtaining at least one packet signature in response to the first prompt, wherein the at least one packet signature is related to the first symptom;
filtering the PCAPs based on the at least one packet signature, wherein filtering the PCAPs includes identifying a set of packet chunks contained in the PCAPs; and
processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

9. The apparatus of claim 8 wherein obtaining the at least one packet signature in response to the first prompt includes obtaining the at least one packet signature from a retrieval-augmented generation (RAG) vector database.

10. The apparatus of claim 9 wherein the at least one packet signature is included in at least one vector embedding, and wherein obtaining the at least one packet signature from the RAG vector database includes extracting at least on chunk of the packet signature from the at least one vector embedding.

11. The apparatus of claim 8 wherein the first symptom is observed in the network in a time range, and wherein identifying the set of packet chunks contained in the PCAPs includes filtering packet sequences included in the PCAPs based on the time range and trimming the packet sequences by removing duplicate packet frames included in the packet sequences.

12. The apparatus of claim 8 wherein filtering the PCAPs based on the at least one packet signature includes creating at least a first vector embedding of the PCAPs, obtaining at least a second vector embedding that includes that at least one packet signature, and performing a semantic similarity calculation on the at least first vector embedding and the at least second vector embedding.

13. The apparatus of claim 12 wherein performing the semantic similarity calculation includes identifying at least a first packet chunk that meets a threshold, the threshold being associated with the at least one packet signature, and wherein the first packet chunk is included in the set of packet chunks.

14. One or more non-transitory computer readable storage media encoded with instructions that, when executed by a processor, cause the processor to perform:
obtaining packet captures (PCAPs), wherein the PCAPs are obtained from a network;
obtaining a first prompt, the first prompt being arranged to identify a first symptom observed in the network;
obtaining at least one packet signature in response to the first prompt, wherein the at least one packet signature is related to the first symptom;
filtering the PCAPs based on the at least one packet signature, wherein filtering the PCAPs includes identifying a set of packet chunks contained in the PCAPs; and
processing the set of packet chunks using at least one large language model (LLM), wherein processing the set of packet chunks includes identifying at least one issue, the at least one issue is characterized by the first symptom, and wherein processing the set of packet chunks further includes creating a summary that summarizes the at least one issue.

15. The one or more non-transitory computer readable storage media of claim 14 wherein the instructions that cause the processor to perform obtaining the at least one packet signature in response to the first prompt include instructions that cause the process to perform obtaining the at least one packet signature from a retrieval-augmented generation (RAG) vector database.

16. The one or more non-transitory computer readable storage media of claim 15 wherein the at least one packet signature is included in at least one vector embedding, and wherein the instructions that cause the processor to perform obtaining the at least one packet signature from the RAG vector database include instructions that cause the processor to perform extracting at least on chunk of the packet signature from the at least one vector embedding.

17. The one or more non-transitory computer readable storage media of claim 15 wherein the first symptom is observed in the network in a time range, and wherein the instructions that cause the processor to perform identifying the set of packet chunks contained in the PCAPs include instructions that cause the processor to perform filtering packet sequences included in the PCAPs based on the time range and trimming the packet sequences by removing duplicate packet frames included in the packet sequences.

18. The one or more non-transitory computer readable storage media of claim 15 wherein the instructions that cause the processor to perform filtering the PCAPs based on the at least one packet signature include instructions that cause the processor to perform creating at least a first vector embedding of the PCAPs, instructions that cause the processor to perform obtaining at least a second vector embedding that includes that at least one packet signature, and instructions that cause the processor to perform performing a semantic similarity calculation on the at least first vector embedding and the at least second vector embedding.

19. The one or more non-transitory computer readable storage media of claim 18 wherein the instructions that cause the processor to perform performing the semantic similarity calculation include instructions that cause the processor to perform identifying at least a first packet chunk that meets a threshold, the threshold being associated with the at least one packet signature, and wherein the first packet chunk is included in the set of packet chunks.

20. The one or more non-transitory computer readable storage media of claim 15 wherein the instructions that cause the processor to perform processing the set of packet chunks using the at least one LLM include instructions that cause the processor to perform providing a plurality of interim insights, the one or more non-transitory computer readable storage media further including:
instructions that cause the processor to perform obtaining a second prompt, wherein creating the summary that summarizes the at least one issue includes processing the plurality of interim insights based on the second prompt.
